(19) United States
(12) Patent Application Publication
(10) Pub. No.: US 2016/0247426 A1
(43) Pub. Date: Aug. 25, 2016

(54) DISPLAY PANEL, PIXEL STRUCTURE AND DRIVING METHOD THEREOF

(71) Applicant: Shenzhen China Star Optoelectronics Technology Co., Ltd., Shenzhen, Guangdong (CN)

(72) Inventor: Shishuai Huang, Shenzhen, Guangdong (CN)

(73) Assignee: Shenzhen China Star Optoelectronics Technology Co., Ltd., Shenzhen, Guangdong (CN)

(21) Appl. No.: 14/417,835

(22) PCT Filed: Jan. 20, 2015
(86) PCT No.: PCT/CN2015/071112

§ 371 Date: May 9, 2016

(30) Foreign Application Priority Data
Oct. 29, 2014 (CN) 201410594781.1

(51) Int. Cl. G09G 3/00; G09G 3/36

(52) U.S. Cl. CPC G09G 3/003; G09G 3/3607; G09G 3/3677; G09G 3/3688; G09G 2300/0426; G09G 2300/0452; G09G 2300/0465; G09G 2310/08; G09G 2320/0209; G09G 2320/0242

(57) ABSTRACT

A display panel, a pixel structure and a driving method thereof are disclosed. The pixel structure comprises a plurality of sub pixels, and each sub pixel comprises a first display area, a second display area, and a third display area. According to the pixel structure of the present disclosure, the color shift phenomenon during 2D display can be reduced, the aperture ratio thereof can be improved, and the cross-talk phenomenon during 3D display can be avoided effectively.

### CROSS REFERENCE TO RELATED APPLICATION

The present application claims benefit of Chinese patent application CN 201410594781.1, entitled “Display Panel, Pixel Structure and Driving Method Thereof” and filed on Oct. 29, 2014, which is incorporated herein by reference.

### FIELD OF THE INVENTION

The present disclosure relates to a liquid crystal display, and particularly to a display panel, a pixel structure and a driving method thereof.

### BACKGROUND OF THE INVENTION

In recent years, display devices are becoming increasingly thin. As such, the Liquid Crystal Display (LCD) has been widely used in a variety of electronic products, such as mobile phones, laptops, color televisions and the like.

However, as to liquid crystal display panel, especially large sized liquid crystal display panel, the color shift phenomenon would occur under wide viewing angles. The larger the viewing angle is, the more serious the color shift phenomenon would be. That is, the color distortion would occur under wide viewing angles.

In order to eliminate the color distortion under wide viewing angles, improve the viewing angle and reduce the color shift thereof, the Low Color Shift (LCS) design is generally used in the design of liquid crystal pixels. In this design, one sub pixel is generally divided into an eight-domain structure, which is shown in FIG. 1. In this pixel structure, part of it is a Main area, and another part of it is a Sub area. The color distortion under wide viewing angles can be eased through controlling the voltages of the Main area and the Sub area.

FIG. 2 is an equivalent circuit diagram of the pixel structure. The pixel can be driven through the following steps. A gate line Gate_n is turned on, and a switch Tmain in the Main area and a switch Tsub in the Sub area are both turned on, so that the charges from a data line (Data_n) can be transmitted to the Main area and the Sub area in the pixel respectively. Then, the gate line Gate_n is turned off, while a gate line Gate_n+1 (which can also be referred to as a share line Share_n) is turned on, and a switch Tcs is turned on, so that part of charges in the Sub area can be released to a charge sharing capacitor Cb. In this case, there would be an electric potential difference between the Main area and the Sub area, so that the color shift phenomenon thereof can be reduced. However, in this pixel structure, in view of the existence of the capacitor Cb, a certain area would be occupied, and thus an aperture ratio of the pixel would be reduced.

In addition, in the traditional LCS design, the pixel is divided into two areas, i.e., the Main area and the Sub area. In this case, however, a cross-talk phenomenon would occur under three dimensional (3D) display mode, and thus the display quality thereof would be reduced.

Therefore, how to solve the aforesaid problems, i.e., how to reduce the color shift phenomenon of the LCD under two dimensional (2D) display mode without the aperture ratio thereof being reduced, and avoid the cross-talk phenomenon under 3D display mode effectively, have become an effort demanding task in the industry.

### SUMMARY OF THE INVENTION

The technical problem to be solved by the present disclosure is to provide a pixel structure used in a display panel, whereby the color shift phenomenon under 2D display mode can be reduced, the aperture ratio thereof can be improved, and the cross-talk phenomenon under 3D display mode can be avoided effectively. In addition, the present disclosure further provides a display panel comprising said pixel structure and a driving method thereof.

In order to solve the aforesaid technical problem, the present disclosure provides a pixel structure, comprising a plurality of sub pixels, each sub pixel comprising: a first display area, configured to receive a scanning signal of a first scanning line and a data signal of a data line, so as to have a first electric potential; a second display area, configured to receive the scanning signal of said first scanning line and the data signal of said data line, so as to have an electric potential equal to said first electric potential; and a third display area, configured to receive a scanning signal of a second scanning line which is adjacent to said first scanning line, so that said second display area has a second electric potential through cutting off an electric potential of the third display area or enabling the third display area to receive the electric potential from said second display area.

According to one embodiment, each display area comprises a switching element, i.e., a first switching element, a second switching element, and a third switching element corresponding to the first, the second, and the third display areas respectively, and each said switching element comprises a gate, a source, and a drain; wherein the gates of the first switching element and the second switching element are both electrically connected with said first scanning line, the sources of the first switching element and the second switching element are both electrically connected with said data line, and the drains of the first switching element and the second switching element are electrically connected with a first sub pixel electrode in the first display area and a second sub pixel electrode in the second display area respectively; and wherein the gate of the third switching element is electrically connected with said second scanning line, the drain of the third switching element is electrically connected with a third sub pixel electrode in the third display area, and the source of the third switching element is electrically connected with the second sub pixel electrode in the second display area.

According to another aspect of the present disclosure, the present disclosure further provides a display panel, comprising: a plurality of data lines; a plurality of scanning lines, configured orthogonally to the plurality of data lines so as to form a plurality of sub pixel areas; and a plurality of sub pixels, configured in said sub pixel areas. Each sub pixel comprises: a first display area, configured to receive a scanning signal of a first scanning line and a data signal of a data line, so as to have a first electric potential; a second display area, configured to receive the scanning signal of said first scanning line and the data signal of said data line, so as to have an electric potential equal to said first electric potential; and a third display area, configured to receive a scanning signal of a second scanning line which is adjacent to said first scanning line, so that said second display area has a second electric potential through cutting off an electric potential of the third display area or enabling the third display area to receive the electric potential from said second display area.

According to one embodiment, each display area comprises a switching element, i.e., a first switching element, a second switching element, and a third switching element corresponding to the first, the second, and the third display areas respectively, and each said switching element comprises a gate, a source, and a drain; wherein the gates of the first switching element and the second switching element are both electrically connected with said first scanning line, the sources of the first switching element and the second switching element are both electrically connected with said data line, and the drains of the first switching element and the second switching element are electrically connected with a first sub pixel electrode in the first display area and a second sub pixel electrode in the second display area respectively; and wherein the gate of the third switching element is electrically connected with said second scanning line, the drain of the third switching element is electrically connected with a third sub pixel electrode in the third display area, and the source of the third switching element is electrically connected with the second sub pixel electrode in the second display area.

According to another aspect of the present disclosure, the present disclosure further provides a method for driving a display panel, said display panel comprising a plurality of data lines, a plurality of scanning lines and a plurality of sub pixels, the plurality of data lines and the plurality of scanning lines being configured orthogonally to each other so as to form a plurality of sub pixel areas, said sub pixels being configured in said sub pixel areas, each sub pixel comprising a first display area, a second display area, and a third display area. Said method comprises: during a two dimensional display mode, transmitting, at a current moment, a data signal to a first display area and a second display area through a data line, so that the first display area and the second display area have a first electric potential respectively; and reducing, at a next moment, the electric potential of said second display area by means of said third display area that is electrically connected with said second display area, so that said second display area has a second electric potential, wherein there is a voltage difference between the second electric potential and the first electric potential.

According to one embodiment, the method further comprises: during the two dimensional display mode, turning on a first scanning line and turning off a second scanning line, at the current moment, so as to turn on a first switching element in the first display area and a second switching element in the second display area, and transmitting a data signal through a data line, so that a first sub pixel electrode in the first display area and a second sub pixel electrode in the second display area have the first electric potential respectively; and turning on said second scanning line and turning off said first scanning line, at the next moment, so as to turn on a third switching element in the third display area, and reducing the electric potential of the second display area by means of a third sub pixel electrode in the third display area, so that the second sub pixel electrode in the second display area has the second electric potential, wherein there is the voltage difference between the second electric potential and the first electric potential; wherein the gates of the first switching element and the second switching element are both electrically connected with said first scanning line, the sources of the first switching element and the second switching element are both electrically connected with said data line, and the drains of the first switching element and the second switching element are electrically connected with a first sub pixel electrode in the first display area and a second sub pixel electrode in the second display area respectively; and wherein the gate of the third switching element is electrically connected with said second scanning line, the drain of the third switching element is electrically connected with a third sub pixel electrode in the third display area, and the source of the third switching element is electrically connected with the second sub pixel electrode in the second display area.

According to another aspect of the present disclosure, the present disclosure further provides a method for driving a display panel, said display panel comprising a plurality of data lines, a plurality of scanning lines and a plurality of sub pixels, the plurality of data lines and the plurality of scanning lines being configured orthogonally to each other so as to form a plurality of sub pixel areas, said sub pixels being configured in said sub pixel areas, each sub pixel comprising a first display area, a second display area, and a third display area. Said method comprising: during a three dimensional display mode, cutting off an electric potential of the third display area in advance, so that the third display area forms a black area; and transmitting, at each moment, a data signal to the first display area and the second display area through a data line, so that the first display area and the second display area have the first electric potential respectively.

According to one embodiment, the method further comprises: during the three dimensional display mode, turning off a second scanning line in advance, and switching off a third switching element in the third display area, so as to cut off an electric potential of the third display area and enable said third display area to form the black area; and turning on, at each moment, a first scanning line, so as to turn on a first switching element in the first display area and a second switching element in the second display area, and transmitting a data signal through a data line, so that a first sub pixel electrode in the first display area and a second sub pixel electrode in the second display area have the first electric potential respectively, wherein the gates of the first switching element and the second switching element are both electrically connected with said first scanning line, the sources of the first switching element and the second switching element are both electrically connected with said data line, and the drains of the first switching element and the second switching element are electrically connected with a first sub pixel electrode in the first display area and a second sub pixel electrode in the second display area respectively; and wherein the gate of the third switching element is electrically connected with said second scanning line, the drain of the third switching element is electrically connected with a third sub pixel electrode in the third display area, and the source of the third switching element is electrically connected with the second sub pixel electrode in the second display area.

Compared with the prior art, one embodiment or a plurality of embodiments of the present disclosure may have the following advantages.

According to the embodiment of the present disclosure, the pixel structure can be divided into three areas, i.e., a Main area, a Sub1 area, and a Sub2 area, whereby an electric potential of the Sub1 area can be reduced by the Sub2 area during 2D display, so that low color shift display effect can be realized. During 3D display, an electric potential of the Sub2 area is cut off to form a black area. In this case, the Sub2 area is maintained in a black state, so that a relatively wide space needed during 3D Film Patterned Retarder (FPR) display can be formed, and thus the cross-talk phenomenon during 3D display can be reduced effectively. Therefore, according to the embodiment of the present disclosure, not only the low color shift display effect can be guaranteed during 2D display without the aperture ratio thereof being reduced, but also the cross-talk phenomenon during 3D display can be reduced, and thus the display effect can be improved.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings are used to provide further understandings of the present disclosure and constitute one part of the description. The drawings are used for interpreting the present disclosure together with the embodiments, not for limiting the present disclosure. In the drawings:

FIG. 1 schematically shows a pixel structure in the prior art;

FIG. 2 is an equivalent circuit diagram of the pixel structure in the prior art;

FIG. 3 schematically shows a structure of a display panel according to one embodiment of the present disclosure;

FIG. 4 schematically shows a pixel structure according to one embodiment of the present disclosure;

FIG. 5 is an equivalent circuit diagram of the pixel structure as shown in FIG. 4;

FIG. 6A and FIG. 6B are time-sequence diagrams of scanning lines and share lines of the equivalent circuit diagram as shown in FIG. 5 during 2D display and 3D display respectively;

FIG. 7 schematically shows a display effect of the pixel structure as shown in FIG. 4 during 3D display;

FIG. 8 is an equivalent circuit diagram of the pixel structure as shown in FIG. 4 during 3D display; and

FIG. 9A and FIG. 9B schematically show viewing angles of display panels comprising the pixel structure in the prior art and the pixel structure as shown in FIG. 4 respectively during 3D display.

### DETAILED DESCRIPTION OF THE EMBODIMENTS

The present disclosure will be illustrated in detail hereinafter in combination with the accompanying drawings to make the purpose, technical solutions, and advantages of the present disclosure more clear.

Reference can be made to FIG. 3, which schematically shows a structure of a display panel according to one embodiment of the present disclosure. The display panel comprises an image display area 100, a source driver 200, and a gate driver 300. The image display area 100 comprises an array formed by a plurality of data lines (which are also referred to as information lines, see the N data lines DL1-DLN as shown in FIG. 3) and a plurality of scanning lines (which are also referred to as gate lines, see the M scanning lines GL1-GLM as shown in FIG. 3) that are configured orthogonally with respect to each other, and a plurality of pixel structures 110. The source driver 200 transmits data signal provided to the image display area 100 through the plurality of data lines coupled therewith; and the gate driver 300 transmits scanning signal provided to the image display area 100 through the plurality of scanning lines coupled therewith.

It should be noted that, the term “pixel structure” referred to herein comprises a plurality of sub pixels, and each sub pixel is configured in a corresponding sub pixel area of the sub pixel areas that are formed by the plurality of data lines and the plurality of scanning lines arranged in a staggered manner with respect to each other. According to the present embodiment, the “sub pixel” may be red (R) sub pixel, green (G) sub pixel, or blue (B) sub pixel, as well as sub pixel with other colors.

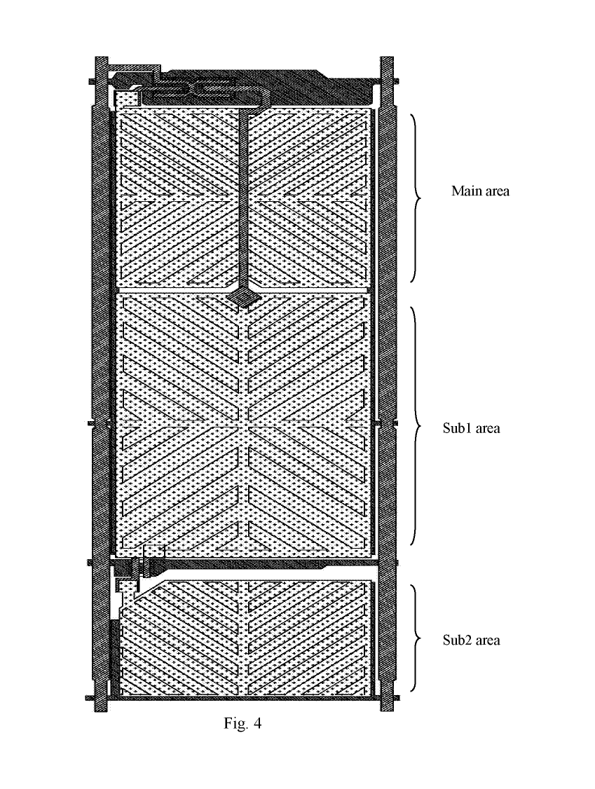

Reference can be made to FIG. 4, which schematically shows a structure of a sub pixel according to one embodiment of the present disclosure. The sub pixel can be applied to the display panel as shown in FIG. 3. As shown in FIG. 4, the sub pixel comprises a first display area (also referred to as a Main area), a second display area (a Sub1 area), and a third display area (a Sub2 area). The Main area is configured to receive a scanning signal of a scanning line Gate_n and a data signal of a data line Data_n, so as to have a first electric potential. The Sub1 area is configured to receive the scanning signal of the scanning line Gate_n and the data signal of the data line Data_n, so as to have an electric potential equal to said first electric potential. The Sub2 area is configured to receive a scanning signal of another scanning line Gate_n+1 (which can also be referred to as a share line Share_n), and receive the electric potential from the Sub1 area so as to have a second electric potential. The share line mainly plays the role of shunting, and is used for reducing the electric potential of the Sub1 area and charging part of the charges of the Sub1 area to the Sub2 area, so that the low color shift display effect can be realized.

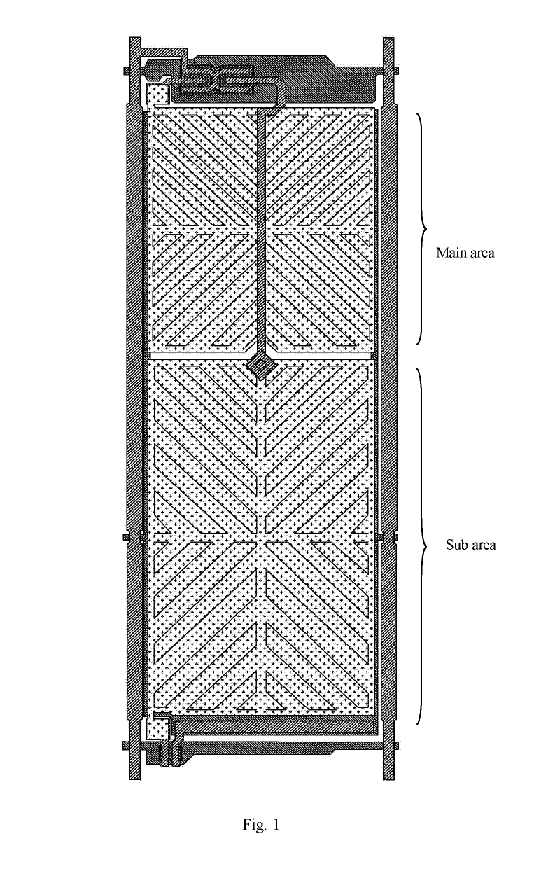

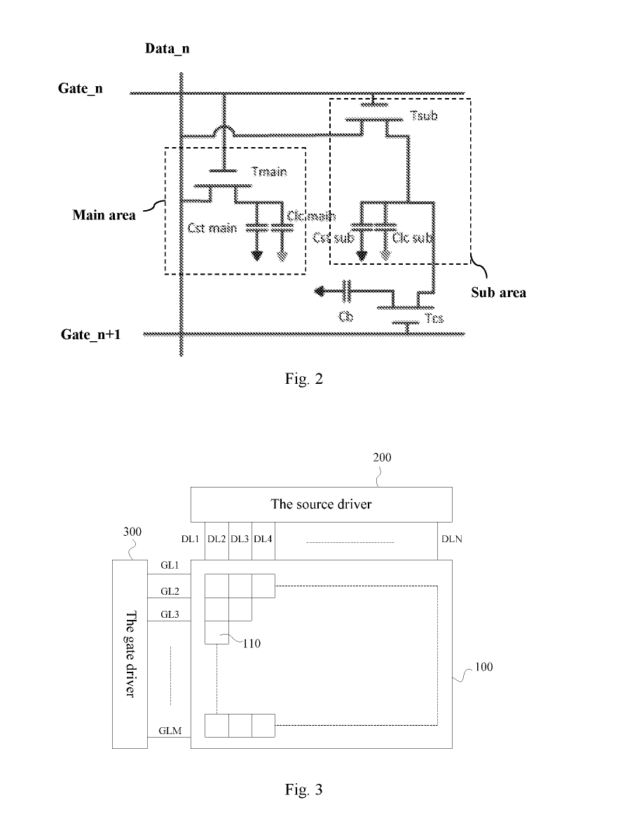

Compared with the pixel structure as shown in FIG. 1, in the embodiment of the present disclosure, the charge sharing capacitor Cb is removed, while the Sub2 area of the sub pixel which is preferably formed by Indium Tin Oxide (ITO) film is added. In this manner, the drop of the aperture ratio thereof can be avoided, and thus the low color shift display effect can be realized.

Each display area comprises a plurality of domains. As shown in FIG. 4, the Main area and the Sub1 area are both divided into four domains, while the Sub2 area is divided into two domains. The data line Data_n is used for transmitting signal to the Main area and the Sub1 area, so as to charge the two areas. The gate line Gate_n is used for turning on the switches of the Main area and the Sub1 area, and the gate line Gate_n+1 is used for turning on the switch of the Sub2 area.

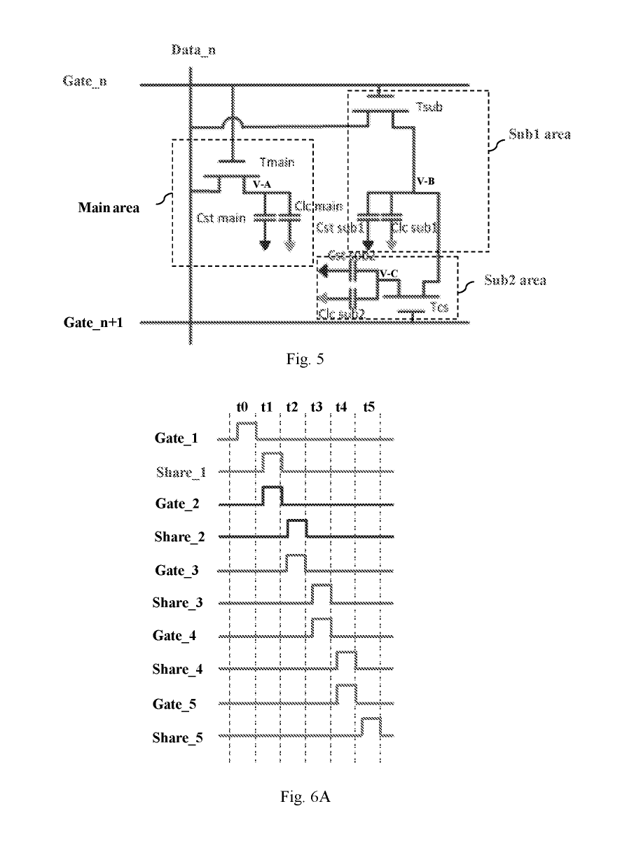

Reference can be made to FIGS. 4 and 5 simultaneously, whereby the whole structure of the sub pixel can be illustrated. FIG. 5 is an equivalent circuit diagram of the sub pixel structure as shown in FIG. 4. The sub pixel comprises switching elements Tₘₐᵢₙ, T_{sub}, and T_{cs}, storage capacitors Cstₘₐᵢₙ, Cst_{sub1}, and Cst_{sub2}, and liquid crystal capacitors Clcₘₐᵢₙ, Clc_{sub1}, and Clc_{sub2}. The switching elements Tₘₐᵢₙ, T_{sub}, and T_{cs} are all preferably made of Thin Film Transistors (TFTs).

In the Main area, the switching element Tₘₐᵢₙ is electrically connected between the data line Data_n and a sub pixel electrode V_A, wherein a control end (i.e., a gate) thereof is electrically connected with the scanning line Gate_n, a source thereof is connected with the data line Data_n, and a drain thereof is connected with the sub pixel electrode V_A of the display area. The storage capacitor Cstₘₐᵢₙ is electrically connected between the sub pixel electrode V_A and a common electrode, and the liquid crystal capacitor Clcₘₐᵢₙ is electrically connected between the sub pixel electrode V_A and another common electrode. When the switching element Tₘₐᵢₙ is turned on, the data signal of the data line Data_n is transmitted to the storage capacitor Cstₘₐᵢₙ through the switching element Tₘₐᵢₙ, and the storage capacitor Cstₘₐᵢₙ is charged according to the data signal and then stored with a corresponding electric potential. Based on this, the sub pixel electrode V_A has the corresponding electric potential also, and thus the Main area displays image data accordingly.

In the Sub1 area, the switching element Tsub is electrically connected between the data line Data_n and a sub pixel electrode V_B, wherein a control end (i.e., a gate) thereof is electrically connected with the scanning line Gate_n, a source thereof is connected with the data line Data_n, and a drain thereof is connected with the sub pixel electrode V_B of the display area. The storage capacitor Cst_{sub1} is electrically connected between the sub pixel electrode V_B and a common electrode, and the liquid crystal capacitor Clc_{sub1} is electrically connected between the sub pixel electrode V_B and another common electrode. When the switching element T_{sub} is turned on, the data signal of the data line Data_n is transmitted to the storage capacitor Cst_{sub1} through the switching element T_{sub}, and the storage capacitor Cst_{sub1} is charged according to the data signal and then stored with a corresponding electric potential. Based on this, the sub pixel electrode V_B has the corresponding electric potential also, and thus the Sub1 area displays image data accordingly.

It should be noted that, in the Sub2 area, the switching element T_{cs} is electrically connected between the sub pixel electrode V_B and a sub pixel electrode V_C, wherein a control end (i.e., a gate) thereof is electrically connected with the scanning line Gate_n+1, a source thereof is connected with the sub pixel electrode V_B of the Sub1 area, and a drain thereof is connected with the sub pixel electrode V_C of this display area. The storage capacitor Cst_{sub2} is electrically connected between the sub pixel electrode V_C and a common electrode, and the liquid crystal capacitor Clc_{sub2} is electrically connected between the sub pixel electrode V_C and another common electrode. When the switching element T_{cs} is turned on, the electric potential of the sub pixel electrode V_B is transmitted to the storage capacitor Cst_{sub2} through the switching element T_{cs}, and the storage capacitor Cst_{sub2} is stored with a corresponding electric potential. In this case, the sub pixel electrode V_C has the corresponding electric potential also, and thus the Sub2 area displays image data accordingly. That is, the electric potential of the sub pixel electrode V_B can be reduced by the Sub2 area.

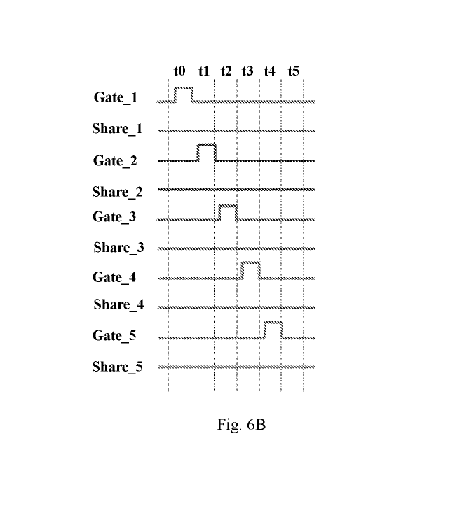

The time-sequences of gate lines and share lines during 2D display and 3D display will be illustrated below with reference to FIGS. 6A and 6B respectively. However, FIGS. 6A and 6B are only directed to specific examples, not used for limiting the present disclosure. That is, the electric potentials of the sub pixel electrodes V_A, V_B, and V_C, which roughly refer to those of the Main area, the Sub1 area, and the Sub2 area respectively, can be regulated according to actual needs without departing from the spirit and scope of the present disclosure.

During 2D display, briefly speaking, the electric potential of the Sub1 area (i.e., the electric potential of the sub pixel electrode V_B) can be reduced by the Sub2 area, so that a certain electric potential difference ΔV can be formed between the Sub1 area and the Main area, and thus a better low color shift display effect can be realized.

Specifically, reference can be made to FIGS. 5 and 6A, wherein during t0 time period, the scanning line Gate_1 outputs a scanning signal (a high-level signal), while a share line Share_1 outputs a low-level signal, so that the switching elements Tₘₐᵢₙ and T_{sub} are both turned on, while the switching element T_{cs} is turned off. During this time period, the switching elements Tₘₐᵢₙ and T_{sub} are both turned on according to the scanning signal, so that the data signal of the data line Data_1 can be transmitted to the storage capacitors Cstₘₐᵢₙ and Cst_{sub1} through the switching elements Tₘₐᵢₙ and T_{sub} respectively. The storage capacitors Cstₘₐᵢₙ and Cst_{sub1} are charged according to the data signal and then stored with corresponding electric potentials respectively, and thus the sub pixel electrodes V_A and V_B have the corresponding electric potentials accordingly. It should be noted that, the electric potential of the Sub1 area is equal to that of the Main area at this time.

Then, during t1 time period, the scanning line Gate_1 outputs a scanning signal (a low-level signal), while the share line Share_1 outputs a high-level signal, so that the switching elements Tₘₐᵢₙ and T_{sub} are both turned off, while the switching element T_{cs} is turned on. The switching element T_{cs} is turned on according to the scanning signal, so that the voltage of the sub pixel electrode V_B can be transmitted to the storage capacitor Cst_{sub2} through the switching element T_{cs}. The storage capacitor Cst_{sub2} is charged and stored with a corresponding electric potential, and thus the sub pixel electrode V_C has the corresponding electric potential accordingly. At this time, a certain voltage difference ΔV can be formed between the Sub1 area and the Main area.

Moreover, during t1 time period, a scanning line Gate_2 also outputs a high-level signal at a triggering moment when the share line Share_1 outputs a high-level signal, while a share line Share_2 outputs a low-level signal, so that the switching elements in the Main area and the Sub1 area of another sub pixel are both turned on, while the switching element in the Sub2 area of said another sub pixel is turned off. During this time period, the switching elements Tₘₐᵢₙ and T_{sub} in the Main area and the Sub1 area of the sub pixel respectively are both turned on according to the scanning signal, so that the data signal of the data line Data_2 can be transmitted to the storage capacitors Cstₘₐᵢₙ and Cst_{sub1} of this sub pixel through the switching elements Tₘₐᵢₙ and T_{sub} respectively. The storage capacitors Cstₘₐᵢₙ and Cst_{sub1} are charged according to the data signal and then stored with corresponding electric potentials respectively, and thus the sub pixel electrodes V_A and V_B of this sub pixel have the corresponding electric potentials accordingly.

Next, during t2 time period, the scanning line Gate_2 outputs a scanning signal (a low-level signal), while the share line Share_2 outputs a high-level signal, so that the switching elements Tₘₐᵢₙ and T_{sub} are both turned off, while the switching element T_{cs} is turned on. The switching element T_{cs} is turned on according to the scanning signal, so that the voltage of the sub pixel electrode V_B can be transmitted to the storage capacitor Cst_{sub2} through the switching element T_{cs}. The storage capacitor Cst_{sub2} is charged and stored with a corresponding electric potential, and thus the sub pixel electrode V_C has the corresponding electric potential accordingly. At this time, a certain voltage difference ΔV can be formed between the Sub1 area and the Main area.

The control methods in other time periods are similar to those in the above time periods, the details of which are no longer repeated here. In this manner, a notable electric potential difference can be formed between the Main area and the Sub1 area, and a delay can be formed between the electric potential of the Sub1 area and the electric potential of the Sub2 area, whereby a notable difference among the images displayed by the three display areas can be formed, and thus the color shift problem of the display panel under 2D display mode can be solved effectively.

During 3D display, briefly speaking, first, the scanning signal in this area is cut off (i.e., the share line is turned off), so that a black area can be formed in the Sub2 area. Since the Sub2 area is maintained in a black state, a relatively wide space needed during 3D FPR display can be formed. At last, the Main area and the Sub1 area are both charged by the data signal of the data line Data_n, so that the 3D display can be realized.

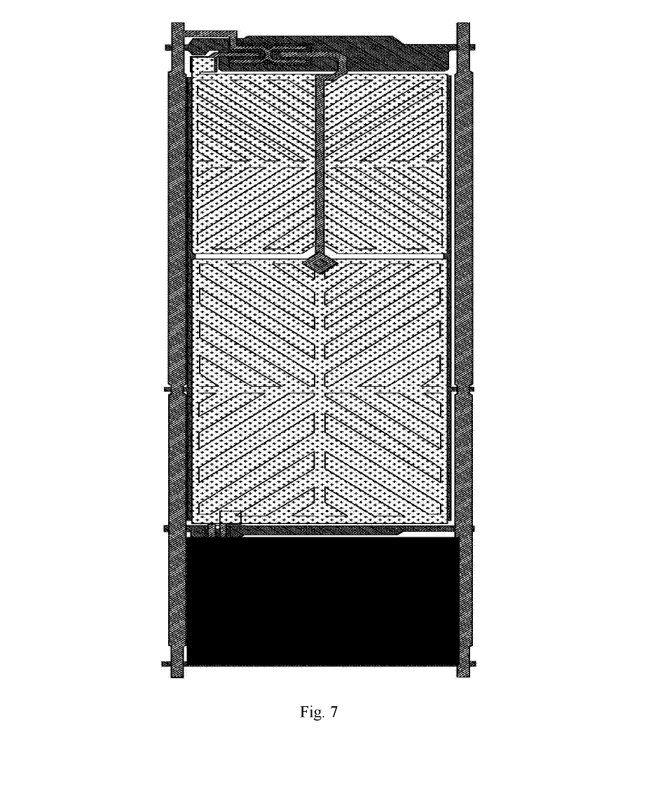

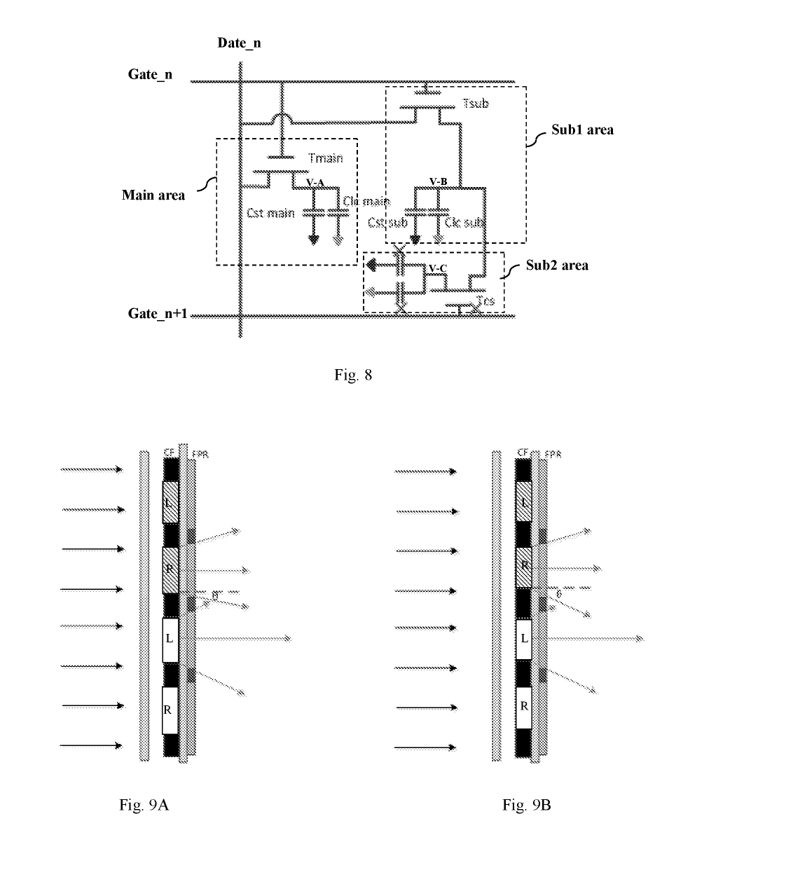

Since the Sub2 area is maintained in a black state, and the scanning signal in this area is cut off, a relatively wide space needed during 3D FPR display can be formed, which is shown in FIG. 7. The equivalent circuit diagram corresponding to FIG. 7 is shown in FIG. 8. Since the scanning line Gate_n+1 is turned off, and the switching element T_{cs} in the Sub2 area is turned off, a black area is formed therein.

Specifically, reference can be made to FIGS. 8 and 6B, wherein during t0 time period of 3D display, the scanning line Gate_1 outputs a scanning signal (a high-level signal), while a share line Share_1 outputs a low-level signal, so that the switching elements Tₘₐᵢₙ and T_{sub} are both turned on, while the switching element T_{cs} is turned off. During this time period, the switching elements Tₘₐᵢₙ and T_{sub} are both turned on according to the scanning signal, so that the data signal of the data line Data_1 can be transmitted to the storage capacitors Cstₘₐᵢₙ and Cst_{sub1} through the switching elements Tₘₐᵢₙ and T_{sub} respectively. The storage capacitors Cstₘₐᵢₙ and Cst_{sub1} are charged according to the data signal and then stored with corresponding electric potentials respectively, and thus the sub pixel electrodes V_A and V_B have the corresponding electric potentials accordingly.

In addition, during other time periods, such as t1, t2, t3, t4, and t5 time periods, the share lines always output low-level signal, and the electric potential of the Sub2 area is cut off, so that a black area can be formed. In this manner, since the Sub2 area is maintained in a black state, a distance between two adjacent sub pixels in vertical direction can be increased. Hence, the viewing angle under 3D display mode can be enlarged, and thus the cross-talk phenomenon under 3D display mode can be eased effectively.

As shown in FIGS. 9A and 9B, FIG. 9A schematically shows a display effect of a display panel comprising the pixel structure in the prior art during 3D display, and FIG. 9B schematically shows a display effect of a display panel comprising the pixel structure of the present embodiment during 3D display. It can be seen that, since the distance between the pixels in two adjacent rows is increased, the influence on the pixels in one row exerted by the pixels in adjacent rows can be reduced. Therefore, the area where the display effect of the pixels in one row is not affected by the pixels in adjacent rows can be enlarged, and thus the viewing angle θ thereof can be enlarged accordingly.

In summary, according to the present embodiment, the pixel structure can be divided into three areas, i.e., the Main area, the Sub1 area, and the Sub2 area, whereby the electric potential of the Sub1 area can be reduced by the Sub2 area during 2D display, so that low color shift display effect can be realized. During 3D display, the electric potential of the Sub2 area is cut off to form a black area. In this case, the Sub2 area is maintained in a black state, so that a relatively wide space needed during 3D FPR display can be formed, and thus the cross-talk phenomenon during 3D display can be reduced effectively. Therefore, according to the present embodiment, not only the low color shift display effect can be guaranteed during 2D display without the aperture ratio thereof being reduced, but also the cross-talk phenomenon during 3D display can be reduced, and thus the display effect can be improved.

The preferred embodiments of the present disclosure are stated hereinabove, but the protection scope of the present disclosure is not limited by this. Any changes or substitutes readily conceivable for any one skilled in the art within the technical scope disclosed by the present disclosure shall be covered by the protection scope of the present disclosure. Therefore, the protection scope of the present disclosure shall be determined by the scope as defined in the claims.

1. A pixel structure, comprising a plurality of sub pixels, each sub pixel comprising:
a first display area, configured to receive a scanning signal of a first scanning line and a data signal of a data line, so as to have a first electric potential;
a second display area, configured to receive the scanning signal of said first scanning line and the data signal of said data line, so as to have an electric potential equal to said first electric potential; and
a third display area, configured to receive a scanning signal of a second scanning line which is adjacent to said first scanning line, so that said second display area has a second electric potential through cutting off an electric potential of the third display area or enabling the third display area to receive the electric potential from said second display area.

2. The pixel structure according to claim 1, wherein each display area comprises a switching element, i.e., a first switching element, a second switching element, and a third switching element corresponding to the first, the second, and the third display areas respectively, and each said switching element comprises a gate, a source, and a drain;
wherein the gates of the first switching element and the second switching element are both electrically connected with said first scanning line, the sources of the first switching element and the second switching element are both electrically connected with said data line, and the drains of the first switching element and the second switching element are electrically connected with a first sub pixel electrode in the first display area and a second sub pixel electrode in the second display area respectively; and
wherein the gate of the third switching element is electrically connected with said second scanning line, the drain of the third switching element is electrically connected with a third sub pixel electrode in the third display area, and the source of the third switching element is electrically connected with the second sub pixel electrode in the second display area.

3. A display panel, comprising:
a plurality of data lines;
a plurality of scanning lines, configured orthogonally to the plurality of data lines so as to form a plurality of sub pixel areas; and
a plurality of sub pixels, configured in said sub pixel areas, each sub pixel comprising:
a first display area, configured to receive a scanning signal of a first scanning line and a data signal of a data line, so as to have a first electric potential;
a second display area, configured to receive the scanning signal of said first scanning line and the data signal of said data line, so as to have an electric potential equal to said first electric potential; and
a third display area, configured to receive a scanning signal of a second scanning line which is adjacent to said first scanning line, so that said second display area has a second electric potential through cutting off an electric potential of the third display area or enabling the third display area to receive the electric potential from said second display area.

4. The display panel according to claim 3, wherein each display area comprises a switching element, i.e., a first switching element, a second switching element, and a third switching element corresponding to the first, the second, and the third display areas respectively, and each said switching element comprises a gate, a source, and a drain;
wherein the gates of the first switching element and the second switching element are both electrically connected with said first scanning line, the sources of the first switching element and the second switching element are both electrically connected with said data line, and the drains of the first switching element and the second switching element are electrically connected with a first sub pixel electrode in the first display area and a second sub pixel electrode in the second display area respectively; and
wherein the gate of the third switching element is electrically connected with said second scanning line, the drain of the third switching element is electrically connected with a third sub pixel electrode in the third display area, and the source of the third switching element is electrically connected with the second sub pixel electrode in the second display area.

5. A method for driving a display panel,
said display panel comprising a plurality of data lines, a plurality of scanning lines and a plurality of sub pixels, the plurality of data lines and the plurality of scanning lines being configured orthogonally to each other so as to form a plurality of sub pixel areas, said sub pixels being configured in said sub pixel areas, each sub pixel comprising a first display area, a second display area, and a third display area,
said method comprising: during a two dimensional display mode,
transmitting, at a current moment, a data signal to a first display area and a second display area through a data line, so that the first display area and the second display area have a first electric potential respectively; and
reducing, at a next moment, the electric potential of said second display area by means of said third display area that is electrically connected with said second display area, so that said second display area has a second electric potential, wherein there is a voltage difference between the second electric potential and the first electric potential.

6. The method according to claim 5, further comprising:
during the two dimensional display mode,
turning on a first scanning line and turning off a second scanning line, at the current moment, so as to turn on a first switching element in the first display area and a second switching element in the second display area, and transmitting a data signal through a data line, so that a first sub pixel electrode in the first display area and a second sub pixel electrode in the second display area have the first electric potential respectively; and
turning on said second scanning line and turning off said first scanning line at the next moment, so as to turn on a third switching element in the third display area, and reducing the electric potential of the second display area by means of a third sub pixel electrode in the third display area, so that the second sub pixel electrode in the second display area has the second electric potential, wherein there is the voltage difference between the second electric potential and the first electric potential;
wherein the gates of the first switching element and the second switching element are both electrically connected with said first scanning line, the sources of the first switching element and the second switching element are both electrically connected with said data line, and the drains of the first switching element and the second switching element are electrically connected with a first sub pixel electrode in the first display area and a second sub pixel electrode in the second display area respectively; and
wherein the gate of the third switching element is electrically connected with said second scanning line, the drain of the third switching element is electrically connected with a third sub pixel electrode in the third display area, and the source of the third switching element is electrically connected with the second sub pixel electrode in the second display area.

7. The method according to claim 5, further comprising:
during a three dimensional display mode,
cutting off an electric potential of the third display area in advance, so that the third display area forms a black area; and
transmitting, at each moment, a data signal to the first display area and the second display area through a data line, so that the first display area and the second display area have the first electric potential respectively.

8. The method according to claim 7, further comprising:
during the three dimensional display mode,
turning off a second scanning line in advance, and switching off a third switching element in the third display area, so as to cut off an electric potential of the third display area and enable said third display area to form the black area; and
turning on, at each moment, a first scanning line, so as to turn on a first switching element in the first display area and a second switching element in the second display area, and transmitting a data signal through a data line, so that a first sub pixel electrode in the first display area and a second sub pixel electrode in the second display area have the first electric potential respectively,
wherein the gates of the first switching element and the second switching element are both electrically connected with said first scanning line, the sources of the first switching element and the second switching element are both electrically connected with said data line, and the drains of the first switching element and the second switching element are electrically connected with a first sub pixel electrode in the first display area and a second sub pixel electrode in the second display area respectively; and
wherein the gate of the third switching element is electrically connected with said second scanning line, the drain of the third switching element is electrically connected with a third sub pixel electrode in the third display area, and the source of the third switching element is electrically connected with the second sub pixel electrode in the second display area.
